(19) United States
(12) Patent Application Publication
(10) Pub. No.: US 2008/0101072 A1
(43) Pub. Date: May 1, 2008

(54) LIGHT EMITTER, IMAGE DISPLAY, AND FABRICATION METHOD THEREOF

(75) Inventors: Kiyohisa Ohta, Hiroshima (JP); Masashi Takemoto, Hiroshima (JP); Nobuo Ogata, Hiroshima (JP)

Correspondence Address: MORRISON & FOERSTER LLP, 1650 TYSONS BOULEVARD, SUITE 400, MCLEAN, VA, 22102, US

(73) Assignee: Sharp Kabushiki Kaisha, Osaka-shi (JP)

(21) Appl. No.: 11/926,703

(22) Filed: Oct. 29, 2007

(30) Foreign Application Priority Data
Oct. 31, 2006 (JP) 2006-296827
Sep. 28, 2007 (JP) 2007-256172

(51) Int. Cl. F21V 7/00; B05D 5/06

(52) U.S. Cl. 362/296; 427/64

(57) ABSTRACT

A light emitter includes reflectors that are spaced apart by a short distance to reduce a thickness of the light emitter. A fabrication method of such light emitters, and an image display using such light emitters are also provided. A light emitter includes: an LED chip 7, reflectors 2 provided on both sides of the LED chip 7, and a second resin layer 4 on which the LED chip 7 and the reflectors 2 are provided. Reflecting faces 9 of the reflectors 2 reflect light emitted by the LED chip 7. In the light emitter, the reflecting faces 9 of the reflectors 2 are formed perpendicular to the second resin layer 4 on which the LED chip 7 is provided.

This Nonprovisional application claims priority under 35 U.S.C. § 119(a) on Patent Application No. 296827/2006 filed in Japan on Oct. 31, 2006, and Patent Application No. 256172/2007 filed in Japan on Sep. 28, 2007, the entire contents of which are hereby incorporated by reference.

### FIELD OF THE INVENTION

The present invention relates to light emitters, and particularly a light emitter having reflectors around a light-emitting element. The invention also relates to an image display using such light emitters, and a fabrication method of such light emitters.

### BACKGROUND OF THE INVENTION

For improved luminance of the LED chip, some light emitters are known to include reflectors around the LED chip.

The reflectors most often use resin.

There are also known light emitters that are intended to improve reflectance by using metal for the reflectors.

A light emitter that uses resin for the reflectors is disclosed, for example, in Japanese Publication for Unexamined Patent Application, No. 2005-294292 (published on Oct. 20, 2005, hereinafter “Patent Publication 1”). Light emitters that use metal for the reflectors are disclosed, for example, in Patent Publication 1, and Japanese Publication for Unexamined Patent Application, Nos. 2004-282004 (published on Oct. 7, 2004, hereinafter “Patent Publication 2”), 2000-58924 (published on Feb. 25, 2000, hereinafter “Patent Publication 3”), 2003-243719 (published on Aug. 29, 2003, hereinafter “Patent Publication 4”), and 2005-294786 (published on Oct. 20, 2005, hereinafter “Patent Publication 5”).

However, as will be described later, such conventional light emitters and image displays have the limitation that the distance between the reflectors or the thickness of the reflectors cannot be reduced due to their fabrication methods and characteristics. This has prevented the thickness of the light emitters from being reduced.

There is also a demand for a thin LED to be used for the backlight of devices such as portable phones, in order to reduce the thickness of these devices.

In conventional light emitters using resin for the reflectors provided around the LED chip, there is a drawback that some of the light rays radiating diagonally upward from the LED chip pass through the resin wall. Accordingly, reflectance of the light emitted by the LED chip is low.

Light emitters using metal for the reflectors provided around the LED chip provides high reflectance and allows the light rays radiating diagonally upward from the LED chip to be reflected out of the light emitter. This type of light emitters therefore provides high luminance.

However, in the light emitters using metal for the reflectors provided around the LED chip, the metal reflectors are generally formed by photolithography or etching. Patent Publication 2 describes using etching to form reflectors around the LED chip.

However, in the technique that forms the metal reflectors by photolithography or etching, the wall faces constituting the metal reflectors are formed by the erosion of a metal plate. As a result, the wall faces are concave in shape. The consequence of this is that the area of the substrate may be reduced in portions where the LED chip is mounted. It is therefore necessary to provide a sufficient space between the reflectors so that the area of the bottom surface defined by the concave faces can be increased. This is a setback against providing a thin light emitter.

In Patent Publication 3, the metal reflectors are formed by pressing of metal. However, it is also difficult with this technique to bend the metal plate perpendicularly to the substrate where the LED chip is mounted. In the technique of Patent Publication 4 in which the metal reflectors are formed by casting, it is also difficult to form the metal plate perpendicular to the LED chip. That is, neither technique can reduce the distance between the reflectors and provide a thin light emitter.

### SUMMARY OF THE INVENTION

The present invention was made in view of the foregoing problems, and it is an object of the present invention to provide a light emitter having reflectors that are spaced apart by a short distance to reduce a thickness of the light emitter, a fabrication method of such light emitters, and an image display using such light emitters.

In order to achieve the foregoing object, the present invention provides a light emitter including: a light-emitting element; a reflector provided on at least one of two opposing sides of the light-emitting element; and a substrate on which the light-emitting element and the reflector are provided, light emitted by the light-emitting element being reflected by an inner wall of the reflector to radiate therefrom, the inner wall of the reflector being formed perpendicular to the substrate.

According to this aspect of the invention, the inner walls of the reflectors are perpendicular to the substrate on which the light-emitting element is provided. That is, the space around the light-emitting element can be reduced while maintaining a sufficient area for anchoring the light-emitting element. In other words, the distance between the reflectors can be reduced while maintaining a necessary die-bonding area. That is, a thin light emitter can be provided.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a diagram representing a fabrication method of a light emitter according to one embodiment of the present invention, showing how reflectors and a second resin layer shown in FIG. 8 are cut by a dicing process at predetermined positions.

FIG. 2 is a diagram representing the fabrication method of a light emitter according to one embodiment of the present invention, showing a state in which a metal layer has been formed on a first resin layer.

FIG. 3 is a diagram representing the fabrication method of a light emitter according to one embodiment of the present invention, showing a state in which the reflectors have been formed by a dicing process that cuts the metal layer and portions of the underlying first resin layer from the side of the metal layer shown in FIG. 2.

FIG. 4 is a diagram representing the fabrication method of a light emitter according to one embodiment of the present invention, showing the second resin layer that has been processed to mount an LED chip.

FIG. 5 is a diagram representing the fabrication method of a light emitter according to one embodiment of the present invention, showing a state in which the second resin layer shown in FIG. 4 has been mated with the reflectors formed on the first resin layer shown in FIG. 3.

FIG. 6 is a diagram representing the fabrication method of a light emitter according to one embodiment of the present invention, showing a state in which a complex of the first resin layer, the reflectors, and the second resin layer shown in FIG. 5 has been flipped over to place the second resin layer on the bottom, and in which the first resin layer has been removed from the reflectors.

FIG. 7 is a diagram representing the fabrication method of a light emitter according to one embodiment of the present invention, showing a state in which a necessary element, an LED chip or the like, is mounted on predetermined portions of the second resin layer shown in FIG. 6.

FIG. 8 is a diagram representing the fabrication method of a light emitter according to one embodiment of the present invention, showing how the LED chip or the like mounted in FIG. 7 is molded with resin.

FIG. 9 is a diagram schematizing an image display of the present invention.

FIG. 10 is a diagram representing a fabrication method of a light emitter according to another embodiment of the present invention, showing how reflectors and a second resin layer shown in FIG. 17 are cut by a dicing process at predetermined positions.

FIG. 11 is a diagram representing the fabrication method of a light emitter according to another embodiment of the present invention, showing a state in which a metal layer has been formed on a first resin layer.

FIG. 12 is a diagram representing the fabrication method of a light emitter according to another embodiment of the present invention, showing a state in which the reflectors have been formed by a dicing process that cuts the metal layer and portions of the underlying first resin layer from the side of the metal layer shown in FIG. 11.

FIG. 13 is a diagram representing the fabrication method of a light emitter according to another embodiment of the present invention, showing the second resin layer on which an LED chip is mounted and that has been processed for this purpose.

FIG. 14 is a diagram representing the fabrication method of a light emitter according to another embodiment of the present invention, showing a state in which the second resin layer shown in FIG. 13 has been mated with the reflectors formed on the first resin layer shown in FIG. 14.

FIG. 15 is a diagram representing the fabrication method of a light emitter according to another embodiment of the present invention, showing a state in which a complex of the first resin layer, the reflectors, and the second resin layer shown in FIG. 14 has been flipped over to place the second resin layer on the bottom, and in which the first resin layer has been removed from the reflectors.

FIG. 16 is a diagram representing the fabrication method of a light emitter according to another embodiment of the present invention, showing a state in which a necessary element, an LED chip or the like, is mounted on predetermined portions of the second resin layer shown in FIG. 15.

FIG. 17 is a diagram representing the fabrication method of a light emitter according to another embodiment of the present invention, showing how the LED or the like mounted in FIG. 16 is molded with resin.

### DESCRIPTION OF THE EMBODIMENTS

### First Embodiment

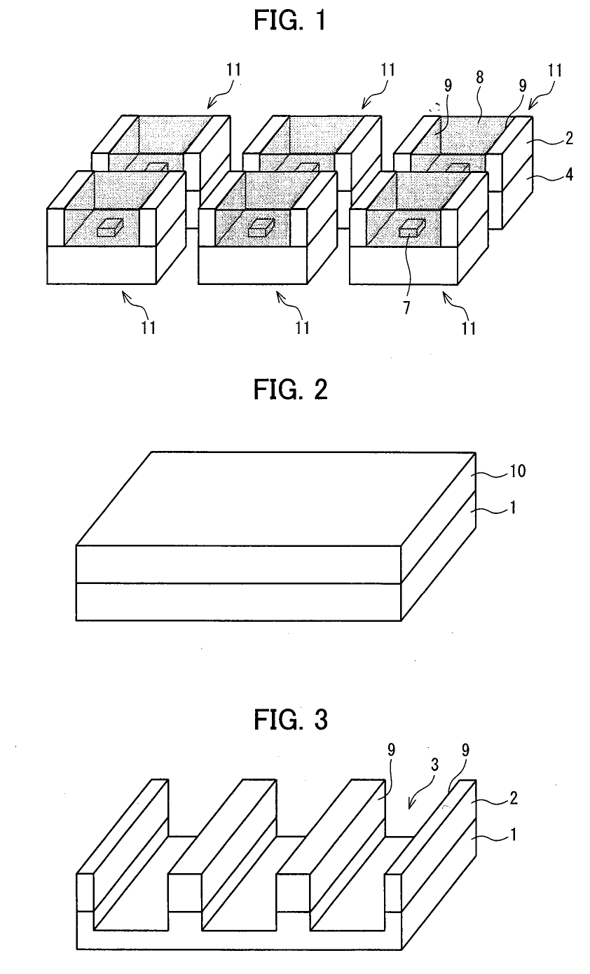

The following will describe one embodiment of the present invention with reference to FIG. 1 through FIG. 9.

FIG. 1 is a diagram depicting light emitters 11 of the present embodiment. In the present embodiment, each light emitter 11 is structured to include an LED chip 7 mounted on a second resin layer 4. A pair of reflectors 2 is provided on the second resin layer 4. An inner surface of each reflector 2 is a reflecting face 9 that reflects light emitted by the LED chip 7. The LED chip 7 and the reflectors 2 are molded by a resin 8.

The second resin layer 4 is provided as a resin layer for mounting the LED chip 7 of the light emitter 11 of the present embodiment. The material of the second resin layer 4 is not particularly limited. For example, the second resin layer 4 is preferably made from a resin substrate such as a phenol resin substrate, or a glass epoxy substrate. The second resin layer 4 corresponds to a “substrate” of the claims.

Electrodes for the LED chip 7 may be connected to the reflectors 2, which are made of metal in this embodiment, so that the reflectors 2 serve as the electrodes of the light emitter 11 in this embodiment.

The material of the reflectors 2 is not particularly limited as long as it can provide the reflecting face 9 for the light emitter 11. The material of the reflectors 2 is suitably selected according to the emission wavelength of the light emitter 11. For example, silver is preferable.

With the reflectors 2 made of metal, reflectance can be improved for the light rays radiating from the LED chip and reflected by the inner wall, where the reflecting face 9 is formed to reflect the radiant rays from the LED chip, as compared with the case where the reflectors 2 are made of resin. Radiant rays traveling obliquely upward from the LED chip emerge from the light emitter 11 through (i) an open face defined by two opposing reflecting faces 9 and facing the second reflecting layer 4, and (ii) an open face defined by the reflecting faces 9 and the second resin layer 4. More specifically, the light rays radiating in this direction from the LED chip are reflected by the reflecting faces 9 toward the upper surface and side surfaces of the resin 8 and emerge from the light emitter 11 through these surfaces. This increases the output of light from the light emitter 11.

In the light emitter 11 of the present embodiment, the reflecting faces 9 are formed on inner surfaces of the reflectors 2, which are formed by cutting a metal layer 10 formed on the second resin layer 4, using a dicing process with a dicing machine. Dicing perpendicularly cuts the metal layer 10 to form the reflecting faces 9. The reflecting faces 9 are therefore perpendicular to the second resin layer 4.

The resin 8 used for molding is not particularly limited. Preferably, the resin 8 is made of a material that can offer mechanical protection for the LED chip 7 and, at the same time, desirable transmission of light through the LED chip 7. One preferable example is epoxy resin. The material of the resin 8 may additionally include a member that can modify the light from the LED chip 7, for example, such as a fluorescent material that converts wavelengths of light from the LED chip 7.

As described above, in the light emitter 11 of the present embodiment, dicing is used to form the reflecting faces 9 on the reflectors 2. This improves precision of the process as compared with the conventional etching process.

In the conventional etching process, the metal layer cannot be etched uniformly due to such factors as a degree of etchant activity. This leads to variations in the thickness of the inner wall, and accordingly variations in the shape of the die-bonding area where the LED chip is anchored. That is, the LED chip cannot provide light at constant efficiency.

Further, in the method employing etching, the metal layer is in principle eroded by the etchant, with the result that the etched wall has a concave face. This means that the area of the substrate may be reduced in portions where the LED chip is mounted.

On the other hand, dicing in the present embodiment perpendicularly cuts the metal layer with respect to the second resin layer 4. The thickness of the inner wall (reflector 2) is therefore uniform, and accordingly the LED chip 7 can output light at constant efficiency.

Further, because the dicing perpendicularly cuts the metal layer with respect to the second resin layer 4, the space around the LED chip 7 can be reduced while maintaining a sufficient die-bonding area where the LED chip 7 or the like is anchored. That is, the distance between the reflectors 2 can be reduced while maintaining a necessary die-bonding area. Further, since the dicing process offers greater precision than etching, the reflectors 2 can be formed with greater accuracy. This enables a large tolerance to be set for any misregistration that might occur in the die-bonding step for the LED chip 7.

The reflecting face 9 formed by dicing may be further processed by etching.

The surface that serves as the reflecting face 9 has scratches attributed to dicing. This may cause scattering of light when light strikes the reflecting face 9. For example, light diagonally falling on the cut surface from below may not reflect upward diagonally.

By etching the reflecting face 9, the surface of the reflecting face 9 can be smoothed. More specifically, by smoothing the cut surface (reflecting face 9) by etching, light diagonally falling on the cut surface from below accurately reflects upward diagonally. This greatly suppresses scattering of light, allowing the reflected light to reach the upper and side surfaces of the resin 8 over short distances. That is, the direction of reflection can be desirably controlled for the radiant rays from the LED chip 7, and as a result the light emitter 11 can emit light at improved efficiency.

Note that, the present embodiment has been described through the case where the metal layer 10 is used as the member processed into the reflectors 2 of the light emitter 11. However, a resin layer may be used instead of the metal layer 10.

The reflecting face 9 may be plated. By plating the reflecting face 9 of the inner wall with metal, radiant rays from the LED chip 7 can be efficiently reflected. In this way, reflectance can be increased and the light emitter 11 can emit light at improved efficiency. The type of metal used for plating is not particularly limited. Preferably, a material is suitably selected according to emission wavelengths of the light emitter 11. A preferable example is silver.

The following will describe a fabrication method of the light emitter 11 according to the present embodiment.

FIG. 2 is a diagram representing a fabrication method of the light emitter 11 according to the present embodiment, showing a state in which a metal layer 10 is formed on a first resin layer 1.

The first resin layer 1 is used for the fabrication of the light emitter 11 of the present embodiment, and the material of which is not particularly limited. The metal layer 10 is formed on the first resin layer 1. It is preferable that the first resin layer 1 do not corrode the metal layer 10. It is also preferable that the first resin layer 1 be made of a material that allows the metal layer 10 to be detached from the first layer 1 without any adhesion when the two layers are separated form each other. The “first resin layer” and the “metal layer 10” correspond to a “resin layer” and “reflecting layer”, respectively, of claims.

The first resin layer 1 and the metal layer 10 are cut by dicing. In dicing, the first resin layer 1 may be anchored on a worktable with an adhesive tape, for example.

FIG. 3 is a diagram representing the fabrication method of the light emitter 11 according to the present embodiment, showing a state in which the reflectors 2 are formed by dicing that cuts the metal layer 10 and a portion of the first resin layer 1 underlying the metal layer 10.

The cutting forms a recessed portion 3 that defines the inner walls of the light emitter 11 in which the LED chip 7 is mounted. The inner walls constitute the reflecting faces 9.

FIG. 4 is a diagram representing the fabrication method of the light emitter 11 according to the present embodiment, showing the second resin layer 4 that has been processed to mount the LED chip 7.

In FIG. 4, the second resin layer 4 is shown with a metal pattern 6, which is formed beforehand to be mated with the reflectors 2. Patterns 5 are also shown that are used for assembly after the LED chips 7 are mounted.

The second resin layer 4 also include other members such as leads to be used for assembly after the LED chip 7 is mounted, and leads used to mount associated elements. The metal pattern 6 where the second resin layer 4 and the reflectors 2 are mated is preferably processed beforehand to enable mating.

Electrodes for the LED chip 7 may be connected to the reflectors 2, which are made of metal in this embodiment, so that the reflectors 2 serve as the electrodes of the light emitter 11 in this embodiment.

The second resin layer 4 is positioned to face the reflectors 2 and mated therewith.

FIG. 5 is a diagram representing the fabrication method of the light emitter 11 according to the present embodiment, showing a state in which the second resin layer 4 has been mated with the reflectors 2 formed on the first resin layer 1 shown in FIG. 3. The second resin layer 4 is mated such that portions thereof to be used for assembly after mounting the LED chip 7 shown in FIG. 4 face the reflectors 2.

The method by which the second resin layer 4 and the reflectors 2 are mated together is not particularly limited. For example, the second resin layer 4 and the reflectors 2 may be bonded together with an adhesive, or a solder may be used to join the reflectors 2 with the metal pattern 6 formed on the second resin layer 4. In the case where a solder is used, a solder layer may be formed beforehand on the reflectors 2, or on the metal pattern 6 formed on the second resin layer 4. Alternatively, the solder layer may be formed by solder plating. It is preferable that portions where the second resin layer 4 and the reflectors 2 are mated together be suitably processed according to the method of bonding employed in the step.

Thereafter, the complex of the first resin layer 1, the reflectors 2, and the second resin layer 4 shown in FIG. 5 is flipped over so that the second resin layer 4 is on the bottom.

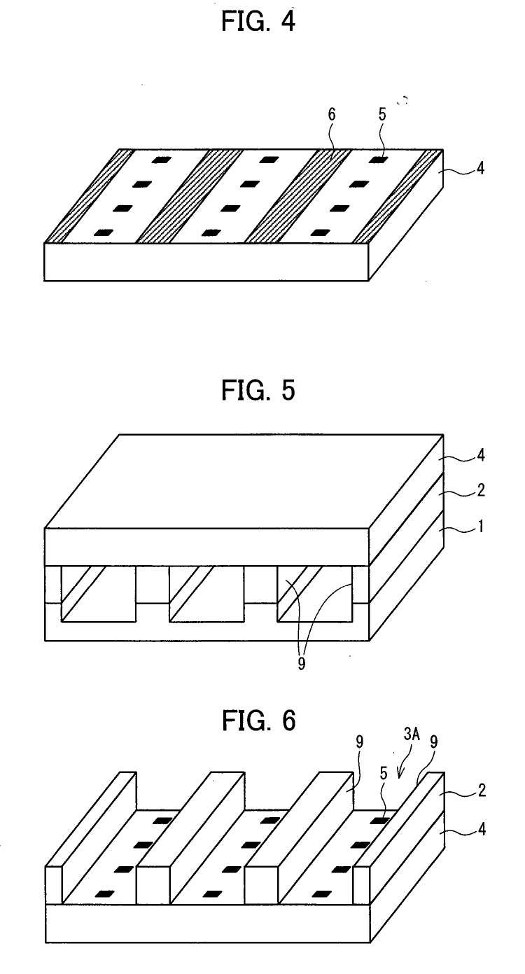

FIG. 6 is a diagram representing the fabrication method of the light emitter 11 according to the present embodiment, showing a state in which the complex of the first resin layer 1, the reflectors 2, and the second resin layer 4 shown in FIG. 5 has been flipped over to place the second resin layer 4 on the bottom, and in which the first resin layer 1 has been removed from the reflectors 2.

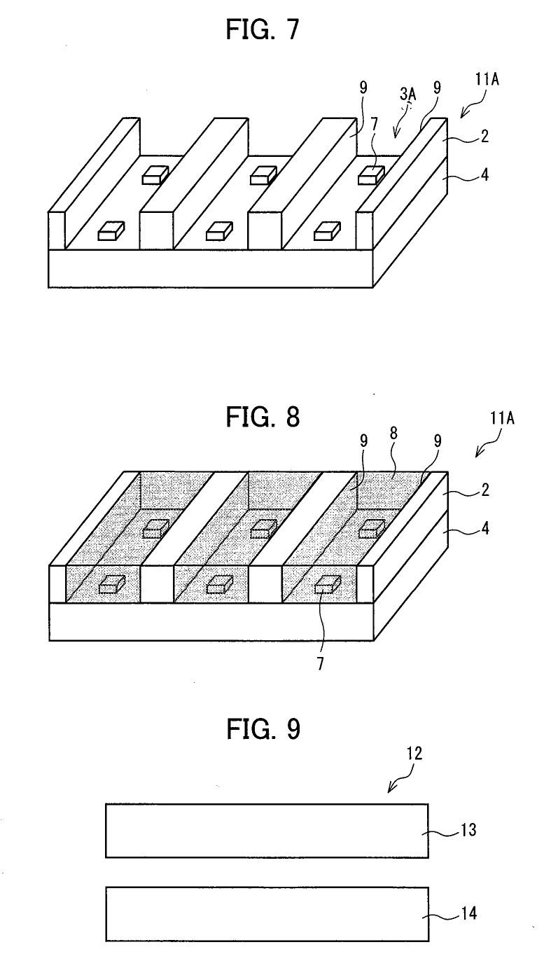

Thereafter, as shown in FIG. 7, necessary elements such as the LED chip 7 are mounted on the pattern 5 that has been formed on the second resin layer 4 for assembly, and a light emitter 11A of a planar shape having a plurality of LED chips 7 is formed. Then, the trench (recessed portion 3A) in which the LED chips 7 have been mounted is molded with the resin 8, as shown in FIG. 8.

Then, the reflectors 2 and the second resin layer 4 molded with the resin 8 as shown in FIG. 8 are cut by dicing at predetermined positions as shown in FIG. 1, so as to provide individual light-emitting elements. In dicing, the second resin layer 4 may be anchored on a worktable or the like with an adhesive tape, for example.

As described above, in the present embodiment, the reflectors of the light emitter are formed by dicing. This makes it possible to reduce the thickness of the light emitter provided with the reflectors. The present invention is therefore applicable to manufacture of various types of light emitters as represented by the light emitter using the LED chip, and manufacture of components of the light emitters. The present invention can also be used to reduce a thickness of a backlight for displays such as liquid crystal displays and PC monitors, and for devices such as portable phones, for example.

In the present embodiment, the first resin layer 1 and the metal layer 10 are cut by dicing to provide the inner wall faces that serve as the reflectors. The inner walls formed by dicing may be subjected to an etching process after the dicing process.

In a method of the present embodiment, dicing cuts the member to be the reflectors of the light emitter, enabling the thickness of the light emitter with the reflectors to be reduced. The invention can also reduce a thickness of a backlight for image displays such as liquid crystal displays or PC monitors, for example.

FIG. 9 is a diagram schematizing an image display 12 of one embodiment of the present invention. The image display 12 includes a liquid crystal panel 13 and a backlight 14. As a light source of the backlight 14, the light emitter 11 of the present embodiment is installed in the backlight 14.

As described above, in the present embodiment, dicing is used to form the reflectors of the light emitter, and this enables the thickness of the light emitter with the reflectors to be reduced. The present invention is therefore applicable to manufacture of various types of light emitters as represented by the light emitter using the LED chip, and manufacture of components of the light emitters. The present invention can also be used to reduce a thickness of a light emitter, such as a backlight, for image displays such as liquid crystal displays and PC monitors, and for devices such as portable phones, for example.

### Second Embodiment

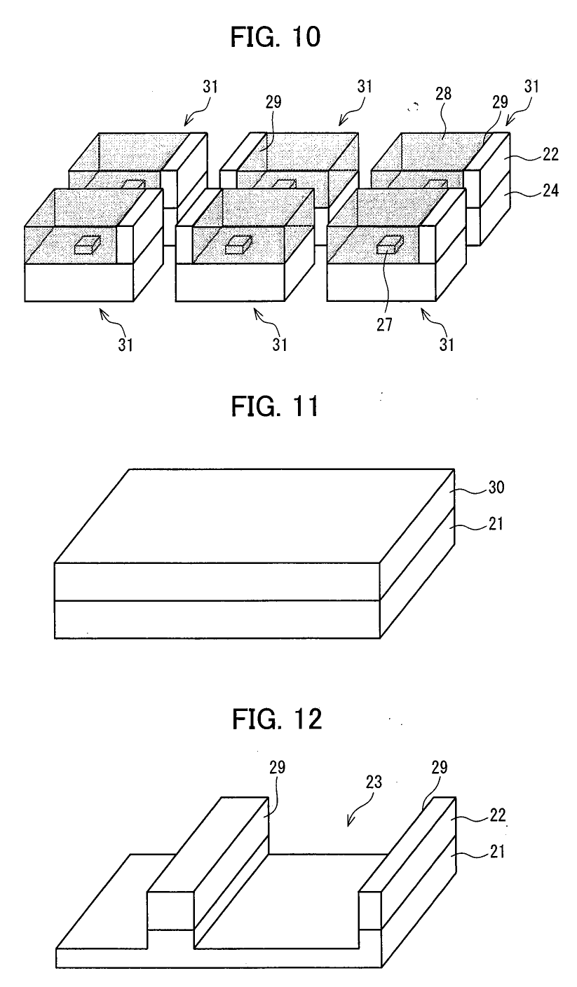

The following will describe another embodiment of the present invention with reference to FIG. 10 through FIG. 17. The foregoing First Embodiment described the case where the reflector is provided on the both sides of the LED chip. The present invention is not limited to this arrangement, and the reflector may be provided only on one side of the LED chip.

FIG. 10 is a diagram depicting light emitters 31 of the present embodiment. In the present embodiment, each light emitter 31 is structured to include an LED chip 27 on a second resin layer 24. A reflector 22 is provided on the second resin layer 24. An inner surface of the reflector 22 is a reflecting face 29 that reflects light emitted by the LED chip 27. The LED chip 27 and the reflector 22 are molded by a resin 28.

The reflector 22 is provided only on one side of the LED chip 27. The reflector 22, the second resin layer 24, and the resin 28 are made of substantially the same materials as those for the reflector 2, the second resin layer 4, and the resin 8, respectively, of the First Embodiment. The LED chip 27 is made of the same material as that for the LED chip 7 of the First Embodiment.

The following will describe a fabrication method of the light emitters 31 of the present embodiment.

FIG. 11 is a diagram representing a fabrication method of the light emitter 31 according to the present embodiment, showing a state in which a metal layer 30 is formed on a first resin layer 21.

The resin layer 21 and the metal layer 30 are made of substantially the same material as those for the first resin layer 1 and the metal layer 10, respectively, shown in FIG. 2.

FIG. 12 is a diagram representing the fabrication method of the light emitter 31 according to the present embodiment, showing a state in which the reflector 22 is formed by dicing that cuts the metal layer 30 and a portion of the first resin layer 21 underlying the metal layer 30.

The cutting forms a recessed portion 23 that defines the inner faces of the light emitter 31 in which the LED chip 27 is mounted. The inner faces constitute the reflecting face 29. The recessed portion 23 is wider than the recessed portion 3. The reflector 22 is wider than the reflector 2 shown in FIG. 3.

FIG. 13 is a diagram representing the fabrication method of the light emitter 31 according to the present embodiment, showing the second resin layer 24 that has been processed to mount the LED chip 27.

The second resin layer 24 is provided with a metal pattern 26, which is formed to be mated with the reflector 22. The second resin layer 24 is also provided with patterns 25 that are used for assembly after the LED chips 27 are mounted. Unlike the patterns 5 shown in FIG. 4 that are formed in a single row between the metal patterns 6, the patterns 25 are formed in two rows between the metal patterns 26 as shown in FIG. 13.

The second resin layer 24 is positioned to face the reflector 22 and mated therewith.

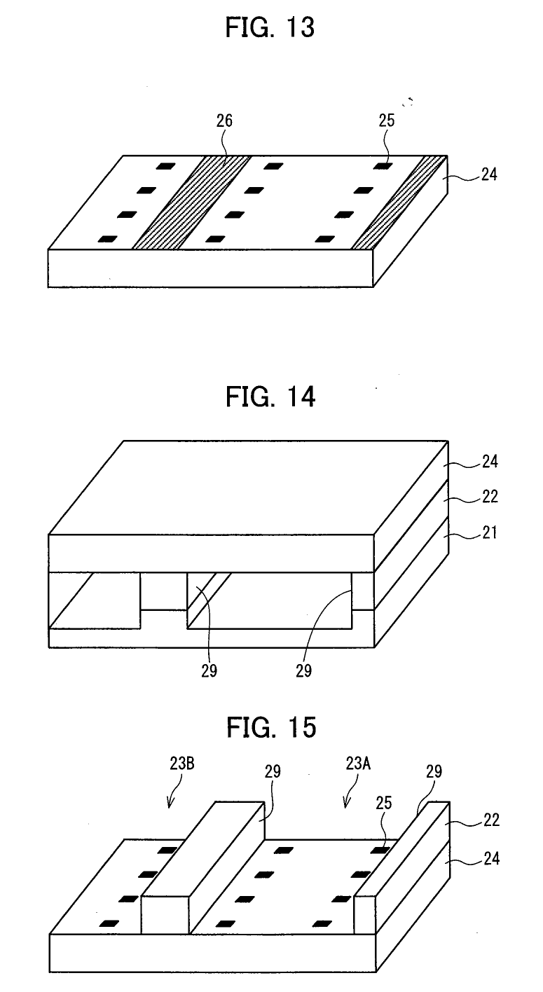

FIG. 14 is a diagram representing the fabrication method of the light emitter 31 according to the present embodiment, showing a state in which the second resin layer 24 has been mated with the reflector 22 formed on the first resin layer 21. The second resin layer 24 is mated such that portions thereof to be used for assembly after mounting the LED chip 27 shown in FIG. 13 face the reflector 22.

Thereafter, a complex of the first resin layer 21, the reflector 22, and the second resin layer 24 shown in FIG. 14 is flipped over so that the second resin layer 24 is on the bottom.

FIG. 15 is a diagram representing the fabrication method of the light emitter 31 according to the present embodiment, showing a state in which the complex of the first resin layer 21, the reflector 22, and the second resin layer 24 shown in FIG. 14 has been flipped over to place the second resin layer 24 on the bottom, and in which the first resin layer 21 has been removed from the reflector 22.

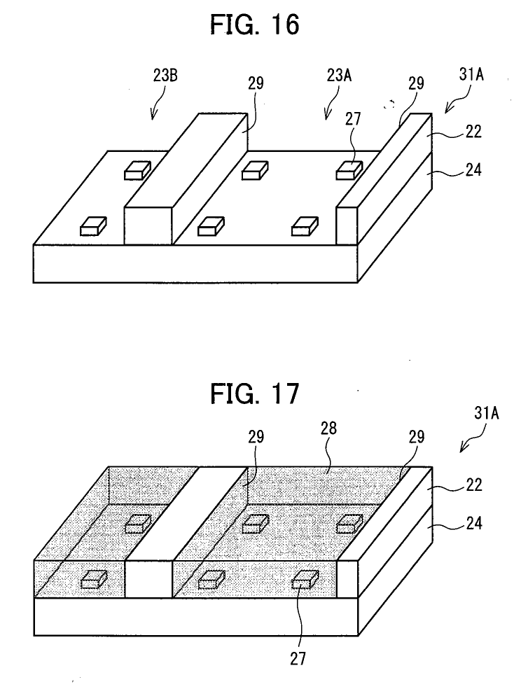

Thereafter, as shown in FIG. 16, necessary elements such as the LED chip 27 are mounted on the pattern 25 that has been formed on the second resin layer 24 for assembly, and a light emitter 31A of a planar shape having a plurality of LED chips 27 is formed. Then, the trench (recessed portion 23A and L-shaped portion 23B) in which the LED chips 27 and other elements have been mounted is molded with the resin 28 as shown in FIG. 17.

Then, the reflector 22 and the second resin layer 24 molded with the resin 28 as shown in FIG. 17 are cut by dicing at predetermined positions as shown in FIG. 10, so as to provide individual light-emitting elements. In dicing, the second resin layer 24 may be anchored on a worktable or the like with an adhesive tape, for example.

The image display 12 shown in FIG. 9 may be provided with the light emitters 31 of the present embodiment as the light source for the backlight 14.

### Summary of the Embodiment

In a light emitter according to one embodiment of the present invention, as described above, the inner walls of the reflectors are formed perpendicular to the substrate.

In a fabrication method of a light emitter according to one embodiment of the present invention, as described above, the reflecting layer is cut by dicing to form the inner walls of the reflectors.

An image display according to one embodiment of the present invention uses the light emitter, as described above.

In a method according to one embodiment of the present invention, since dicing is used to form the inner walls of the reflectors, precision of the process can be improved as compared with the conventional etching process.

The dicing process can cut the inner walls of the reflectors perpendicularly. This provides a uniform thickness for the reflectors, and enables the light-emitting element to emit light at constant efficiency.

Because the inner walls of the reflectors are formed perpendicular to the substrate on which the light-emitting element is provided, the space around the light-emitting element can be reduced while maintaining a sufficient area for anchoring the light-emitting element. Accordingly, a die-bonding area for anchoring the light-emitting element or other components can be formed uniformly. It is therefore possible to reduce the distance between the reflectors while maintaining a necessary die-bonding area. That is, a thin light emitter can be provided.

Further, since the dicing process offers greater precision than the conventional etching and other processes, the inner walls of the reflectors can be formed with greater accurately. This enables a large tolerance to be set for any misregistration that might occur in the die bonding step for the light-emitting element.

An image display according to one embodiment of the present invention is manufactured using the light emitter. The image display is therefore thin.

It is therefore possible to provide a light emitter having reflectors that are spaced apart by a short distance to reduce a thickness of the light emitter, as well as a fabrication method of such light emitters, and an image display using such light emitters.

In a light emitter of one embodiment of the present invention, it is preferable that the light-emitting element be an LED element, and that the inner walls of the reflectors be formed by dicing.

In order to solve the foregoing problems, an image display according to one embodiment of the present invention uses the light emitter.

According to this aspect of the invention, the image display includes the reflectors whose inner walls are formed perpendicularly with respect to the substrate on which the light-emitting element is formed. That is, the space around the light-emitting element can be reduced while maintaining a sufficient area for anchoring the light-emitting element. It is therefore possible to reduce the distance between the reflectors while maintaining a necessary die-bonding area. That is, a thin light emitter can be provided.

An image display according to one embodiment of the present invention is manufactured using a light emitter of one embodiment of the present invention. That is, a thin image display can be provided.

In a light emitter according to one embodiment of the present embodiment, it is preferable that the inner walls of the reflectors be made of metal.

With the inner walls of the reflectors made of metal, the radiant rays from the light-emitting element can be efficiently reflected into the open face defined in the light emitter by the reflectors and facing the substrate, and open faces defined in the light emitter by the reflectors and the substrate.

In a light emitter according to one embodiment of the present invention, it is preferable that the inner walls of the reflectors be formed by dicing followed by etching.

In this way, the diced surface can be smoothed by the etching that is performed on the inner walls of the reflectors after the dicing. By smoothing the inner walls of the reflectors, the light emitted by the light-emitting element can be guided over short distances onto the open face defined in the light emitter by the reflectors and facing the substrate, and open faces defined in the light emitter by the reflectors and the substrate, without causing much scattering.

In a light emitter according to one embodiment of the present invention, it is preferable that the inner walls of the reflectors be plated with metal, and that silver be used for the plating.

In this way, by plating the inner walls of the reflectors with metal, the radiant rays from the light-emitting element can be efficiently reflected. That is, the light emitter can emit light at improved efficiency.

In a light emitter according to one embodiment of the present invention, it is preferable that the inner walls of the reflectors be electrically connected to the electrodes provided for the light-emitting element.

By the electrical connection between the reflectors and the electrodes, the heat of the LED chip can easily be conducted through the electrodes.

In order to solve the foregoing problems, a fabrication method of a light emitter according to one embodiment of the present invention is a method for fabricating a light emitter including a reflector on at least one of two opposing sides of a light-emitting element, the method including the steps of: forming a reflecting layer on a resin layer; forming a reflector by cutting the reflecting layer to the resin layer; bonding a substrate with the reflector on the opposite side of the resin layer with respect to the reflector; removing the resin layer from the reflector; and mounting the light-emitting element on a side of the substrate facing the reflector, the step of forming the reflector by cutting the reflecting layer to the resin layer being performed by dicing that cuts the reflecting layer to form an inner wall defining the reflector.

In a fabrication method of a light emitter according to one embodiment of the present invention, it is preferable that the reflectors be made of metal, and that the inner walls of the reflectors be formed perpendicular to the substrate.

According to this aspect of the invention, since dicing is used to form the inner walls of the reflectors, precision of the process can be improved as compared with the conventional etching process.

Further, the dicing process can cut the inner walls of the reflectors perpendicularly. This provides a uniform thickness for the reflectors, and enables the light-emitting element to emit light at constant efficiency.

With the inner walls of the reflectors made of metal, the radiant rays from the light-emitting element can be efficiently reflected into the open face defined in the light emitter by the reflectors and facing the substrate, and open faces defined in the light emitter by the reflectors and the substrate.

In a fabrication method of a light emitter according to one embodiment of the present invention, it is preferable that the step of bonding a substrate with the reflector on the opposite side of the resin layer with respect to the reflector include the step of forming a solder layer of plated solder, prior to the bonding, on a surface of the substrate mated with the reflector.

In Patent Publication 5, a reflecting member made of a metallic material is bonded onto a circuit substrate with a solder or a metal paste. In the foregoing configuration of the present invention, the reflectors are formed on the substrate by solder plating. It is therefore not required to bond the reflectors using a solder or a paste as in Patent Publication 5.

In a fabrication method of a light emitter according to one embodiment of the present invention, it is preferable that the step of forming the reflector by cutting the reflecting layer to the resin layer be performed by dicing that cuts the reflecting layer and subsequent etching that forms the inner wall of the reflector.

A fabrication method of a light emitter according to one embodiment of the present invention preferably includes a further step of metal-plating the inner wall of the reflector.

In a fabrication method of a light emitter according to one embodiment of the present invention, it is preferable that silver be used for the metal plating.

In a fabrication method of a light emitter according to one embodiment of the present invention, it is preferable that the light-emitting element mounted in the step of mounting the light-emitting element on a side of the substrate facing the reflector be one of a plurality of light-emitting elements, and that the method further include the step of dividing the light emitter into a plurality of light emitters each having the light-emitting element.

In a fabrication method of a light emitter according to one embodiment of the present invention, it is preferable that the light-emitting element mounted in the step of mounting the light-emitting element on a side of the substrate facing the reflector constitute a single row of light-emitting elements between reflectors, and that the light emitter in the step of dividing the light emitter into a plurality of light emitters each having the light-emitting element be divided on a plane through the reflector, perpendicular to a surface of the substrate and parallel to a direction along the row of the light-emitting elements, and on a plane between the light-emitting elements, perpendicular to the surface of the substrate and perpendicular to the direction along the row of the light-emitting elements, so as to provide a plurality of light emitters each having the reflectors on both sides of the light-emitting element.

In a fabrication method of a light emitter according to one embodiment of the present invention, it is preferable that the light-emitting element mounted in the step of mounting the light-emitting element on a side of the substrate facing the reflector constitute two rows of light-emitting elements between reflectors, and that the light emitter in the step of dividing the light emitter into a plurality of light emitters each having the light-emitting element be divided on a plane through the reflector, perpendicular to a surface of the substrate and parallel to a direction along the rows of the light-emitting elements, and on a plane between the light-emitting elements, perpendicular to the surface of the substrate and parallel to the direction along the rows of the light-emitting elements, and on a plane between the light-emitting elements, perpendicular to the surface of the substrate and perpendicular to the direction along the rows of the light-emitting elements, so as to provide a plurality of light emitters each having the reflector on one side of the light-emitting element.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A light emitter comprising:
a light-emitting element;
a reflector provided on at least one of two opposing sides of the light-emitting element; and
a substrate on which the light-emitting element and the reflector are provided,
light emitted by the light-emitting element being reflected by an inner wall of the reflector to radiate therefrom,
the inner wall of the reflector being formed perpendicular to the substrate.

2. The light emitter as set forth in claim 1, wherein the light-emitting element is an LED element.

3. The light emitter as set forth in claim 1, wherein the inner wall of the reflector is formed by dicing.

4. The light emitter as set forth in claim 1, wherein the inner wall of the reflector is made of metal.

5. The light emitter as set forth in claim 4, wherein the inner wall of the reflector is formed by dicing followed by etching.

6. The light emitter as set forth in claim 1, wherein the inner wall of the reflector is plated with metal.

7. The light emitter as set forth in claim 6, wherein silver is used for the plating.

8. The light emitter as set forth in claim 4, wherein the reflector is electrically connected to an electrode provided for each of the two opposing sides of the light-emitting element.

9. A fabrication method of a light emitter including a reflector on at least one of two opposing sides of a light-emitting element,
said method comprising the steps of:
forming a reflecting layer on a resin layer;
forming a reflector by cutting the reflecting layer to the resin layer;
bonding a substrate with the reflector on the opposite side of the resin layer with respect to the reflector;
removing the resin layer from the reflector; and
mounting the light-emitting element on a side of the substrate facing the reflector,
said step of forming the reflector by cutting the reflecting layer to the resin layer being performed by dicing that cuts the reflecting layer to form an inner wall defining the reflector.

10. The fabrication method as set forth in claim 9,
wherein the reflector is made of metal, and
wherein the inner wall of the reflector is formed perpendicular to the substrate.

11. The fabrication method as set forth in claim 9, wherein the step of bonding a substrate with the reflector on the opposite side of the resin layer with respect to the reflector includes the step of forming a solder layer of plated solder, prior to the bonding, on a surface of the substrate mated with the reflector.

12. The fabrication method as set forth in claim 10, wherein the step of forming the reflector by cutting the reflecting layer to the resin layer is performed by dicing that cuts the reflecting layer and by subsequent etching that forms the inner wall of the reflector.

13. The fabrication method as set forth in claim 9, further comprising the step of metal-plating the inner wall of the reflector.

14. The fabrication method as set forth in claim 13, wherein silver is used for the metal plating.

15. The fabrication method of a light emitter as set forth in claim 9,
wherein the light-emitting element mounted in the step of mounting the light-emitting element on a side of the substrate facing the reflector comprises a plurality of light-emitting elements, and
wherein the method further comprises the step of dividing the light emitter into a plurality of light emitters each having the light-emitting element.

16. The fabrication method of a light emitter as set forth in claim 15,
wherein the light-emitting element mounted in the step of mounting the light-emitting element on a side of the substrate facing the reflector comprises a single row of light-emitting elements between reflectors; and
wherein the light emitter in the step of dividing the light emitter into a plurality of light emitters each having the light-emitting element is divided on a plane through the reflector, perpendicular to a surface of the substrate and parallel to a direction along the row of the light-emitting elements, and on a plane between the light-emitting elements, perpendicular to the surface of the substrate and perpendicular to the direction along the row of the light-emitting elements, so as to provide a plurality of light emitters each having the reflectors on both sides of the light-emitting element.

17. The fabrication method of a light emitter as set forth in claim 15,
wherein the light-emitting element mounted in the step of mounting the light-emitting element on a side of the substrate facing the reflector comprises two rows of light-emitting elements between reflectors; and
wherein the light emitter in the step of dividing the light emitter into a plurality of light emitters each having the light-emitting element is divided on a plane through the reflector, perpendicular to a surface of the substrate and parallel to a direction along the rows of the light-emitting elements, and on a plane between the light-emitting elements, perpendicular to the surface of the substrate and parallel to the direction along the rows of the light-emitting elements, and on a plane between the light-emitting elements, perpendicular to the surface of the substrate and perpendicular to the direction along the rows of the light-emitting elements, so as to provide a plurality of light emitters each having the reflector on one side of the light-emitting element.

18. An image display using a light emitter that includes: a light-emitting element; a reflector provided on at least one of two opposing sides of the light-emitting element; and a substrate on which the light-emitting element and the reflector are provided, light emitted by the light-emitting element being reflected by an inner wall of the reflector to radiate therefrom, the inner wall of the reflector being formed perpendicular to the substrate.
